(19) United States
(12) Patent Application Publication
(10) Pub. No.: US 2019/0066893 A1
(43) Pub. Date: Feb. 28, 2019

(54) Universal Magnetic Sealed Unit

(71) Applicant: Tseng-Lu Chien, Walnut, CA (US)

(72) Inventor: Tseng-Lu Chien, Walnut, CA (US)

(21) Appl. No.: 15/685,472

(22) Filed: Aug. 24, 2017

(51) Int. Cl. H01F 7/02

(52) U.S. Cl. CPC H01F 7/02

(57) ABSTRACT

The Universal magnet sealed-unit has never fall apart magnetic-piece from product and offer simple magnetic attachment function or-and offer multiple functions including all kind of electric related functions for all kind of product. The sealed-unit has opening to allow inner magnetic-piece to pop-out to contact with metal-piece while metal-piece location within the magnetic-force range and magnetic-piece will back to recess of opening position or horizon position inside the sealed unit while the metal-piece is away from magnetic-force range. The magnetic-piece do not fall-apart from sealed-unit by balance or gravity theory with optional stop or block-design. Sealed unit may incorporate with conductive-piece or-and IC or-and Circuit or-and circuitry to get multiple electric functions as pre-determined electric or electronic or wireless functions.

### BACKGROUND

The markets had a lot of products had round magnetic-pieces installed on back of the products so products can use magnetic-pieces to be installed or be fixed on the metallic surfaces. However, these magnetic-pieces majority are rounded-shape like a cylinder which are put into or tighten into a recess cylinder-holes. However, the product majority materials may have physical deforming shapes and dimensions for the recess cylinder-holes, so many such cylinder magnetic-piece will fell apart or separated from the products, causing the products to fall down from metallic surfaces and inflict damages to products.

The current invention teaches a never fall-apart magnetic piece from products. The current invention for Universal magnetic sealed-unit has features including

(1) very simple to add on all products or by simple tooling or installation by screw or metal-plastic or fit tight or physical fitting, or-and

(2) pop-out from recess position while attaching on metallic surface and had stop-kit to prevent from falling apart or separating from product, or-and

(3) back to recess position while no metallic surface within pre-determined distance by weight balance-theory or-and gravity theory, or-and

(4) All product can make simple tooling only need some screw holes or some poles. Can easily open tooling molds for all products so the current invention is a typical universal magnetic sealed-unit for wide application to any products need magnetic function to install product on the metal surface, or-and

(5) The current invention for universal magnetic sealed-unit not only offer the never fall apart magnetic-piece functions but also offer the current delivery while the universal magnetic sealed-unit(s) incorporated with conductive metal piece and contact with metal surface, so can get input current to pass though conductive piece to magnetic-piece of universal magnetic sealed unit to metal surface. Or/and

(6) The current invention for Universal magnetic sealed-unit has at least have 2 types:
(a) Only offer magnetic field to allow product can be fixed or installed on metal surface.
(b) Has magnetic-piece incorporated with conductive piece or circuitry to delivery Electric Current and has magnetic field to allow product can fix or install on Metal surface.

### DRAWING

FIG. 1: Disclosed the one of preferred embodiment for traditional market product has round or cylinder magnetic-piece fit into products round or cylinder hole which fall apart easily.

FIG. 2: Show the current invention one of construction which is a universal magnetic sealed-unit has inside magnetic-piece in a rectangular body and one opening which Opening/hole to allow inner magnetic-piece to tilt/pop-out and stop while has the said metal-piece within the magnetic field range. Inside the sealed-unit, all the time has inner rectangular body which has longer length/heavier weight-body and the said longer length/heavier weight-body inside sealed unit that is more than the lesser length/lighter weight-body that exposure or install on top of opening, so basing on balance-theory while no metal-piece within the magnetic field range will cause the rectangular body from tilt/pop-out position back to the horizon position.

FIG. 3: Disclosure the current invention one of the application which has sealed-unit install on the back of the product so can attach or fix or install the said universal magnetic sealed-unit on the metal surface and stay well by magnetic force without any worry magnetic-piece been separated by the strong magnetic-field force with metal surface than the weak hold-force between fit-tight or glue-tight magnetic-piece inside the holes.

FIG. 4: Disclosure the alternative embodiment which not only had the magnetic function but also has the delivery of electrical current functions while incorporate with conductive parts or/and circuitry or/and IC or/and controller system so can deliver or make desired electric functions.

FIG. 5 and FIG. 6: Disclosure some other products which has the battery compartment on back of the products and the current invention universal magnetic sealed-units on the back housing of the products.

### DESCRIPTION

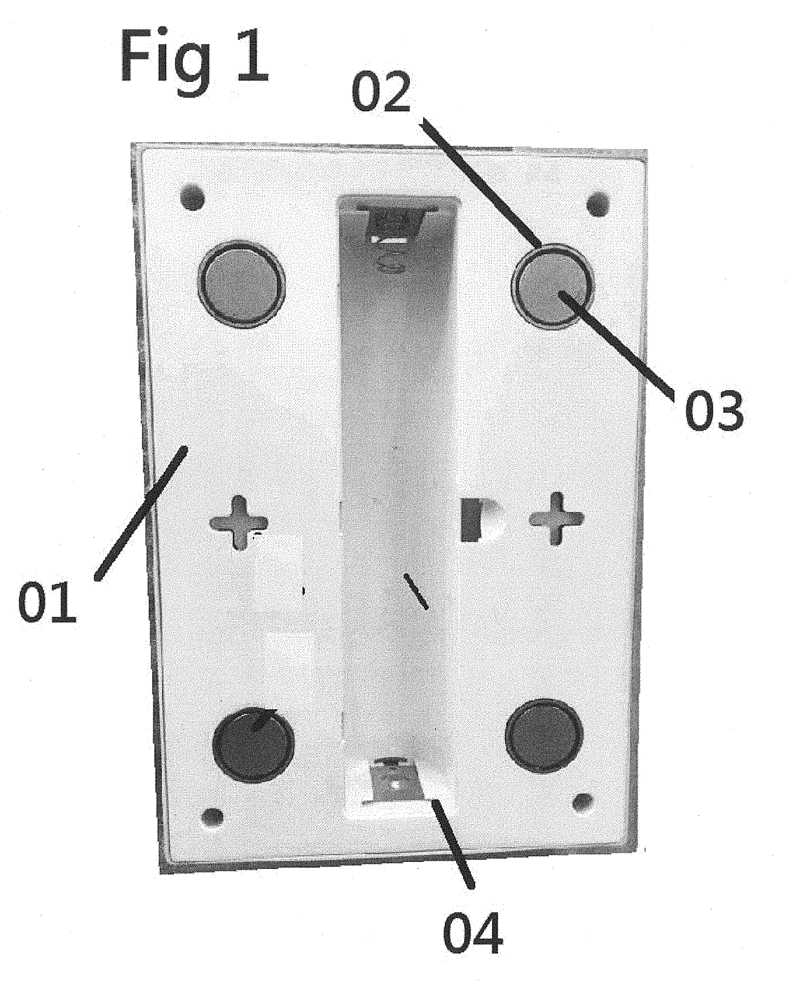

From FIG. 1 shown the tradition market old product (01) has magnetic-piece (03) on back recess round or cylinder holes (02) and has battery compartment (04). This kind of product majority is made by plastic injection process and the plastic normally is very cheap so will have big impact for heat or temperatures to make the plastic deforming and enlarge the recess round or cylinder holes so the magnetics for push-tight or glue will be loosen easily. The magnetic-piece (03) has different magnetic force basing on different specification, so very powerful magnetic-force will also stronger than the fit-tight or push-tight holding force, so magnetic-piece will instantly been pull-out from recess round or cylinder holes. This is what the big problem for all prior arts.

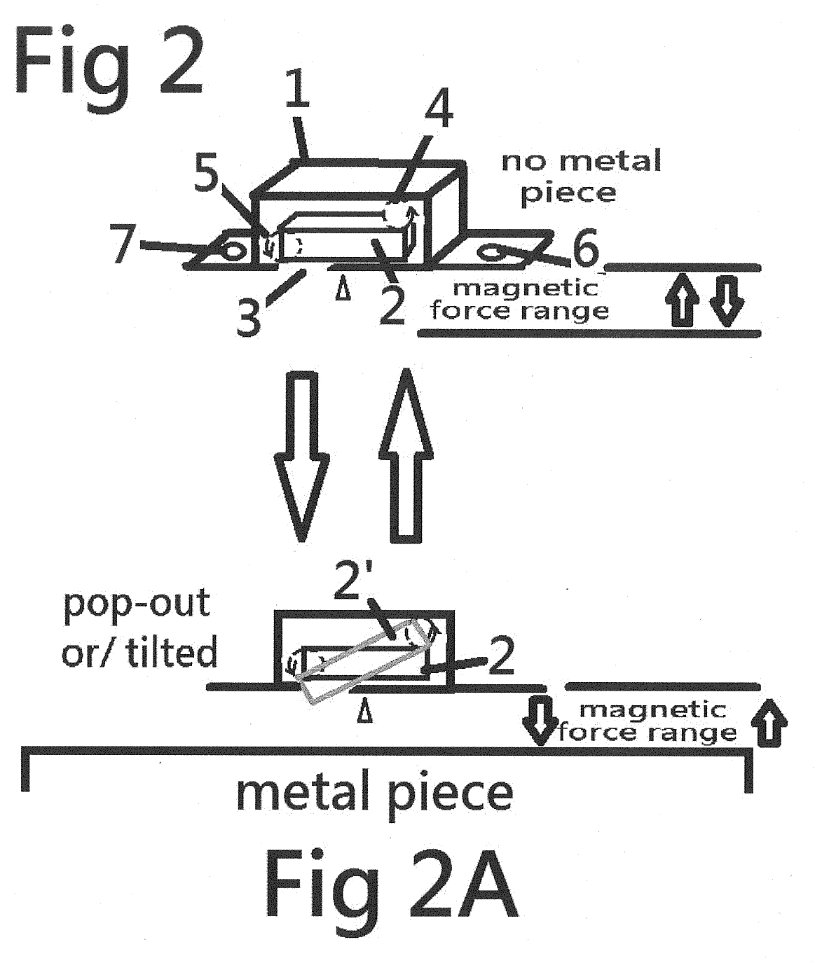

From FIG. 2 and FIG. 2A disclosure the current invention make a big improvement for traditional market push-tight or fit-tight or glue-tight for recess holes. From FIG. 2 is a universal magnetic sealed-unit (1) which has inner magnetic-piece (2) which can pop-out (2′) or tilt (2′) to connect with metal-piece surface (Not shown) while the metal-piece (shown on FIG. 2A) is within the magnetic-piece magnetic-force.

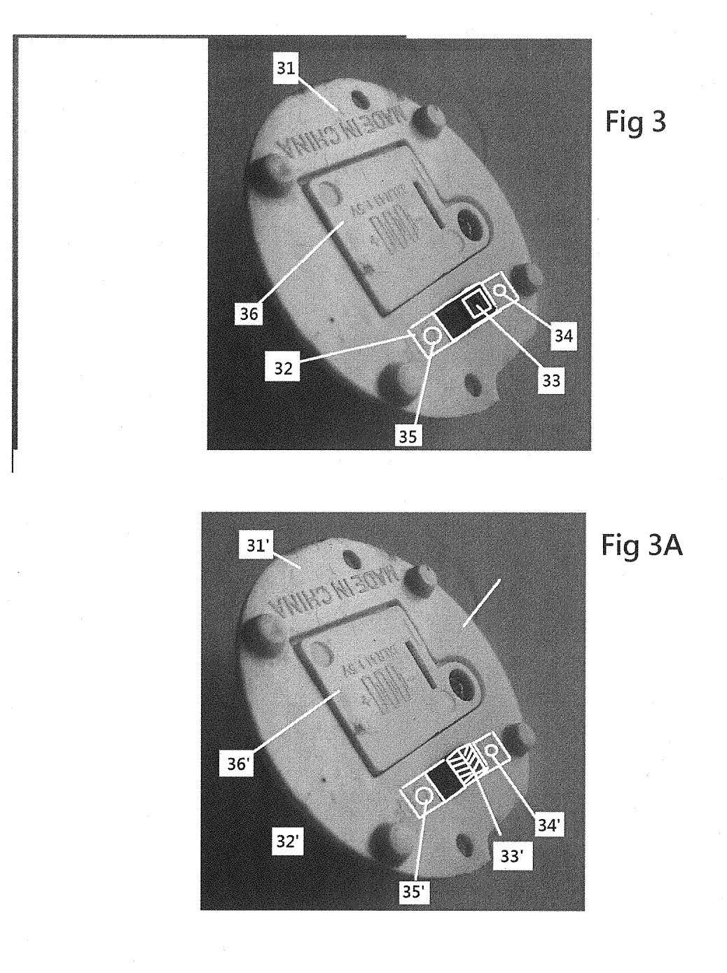

From FIG. 2 and FIG. 2A can see the magnetic-piece (2) while not pop-out or tilt because no any metal-piece is into the range of magnetic-force of magnetic-piece (2). While the metal-piece is fall within the magnetic-piece (2) magnetic force range, the magnetic-piece will change position from FIG. 2 (2) horizon or recess position (2) to pop-out or tilt position FIG. 3 (2′). While the universal sealed-unit is away from metal-piece, the pop-out (2′) or tilt (2′) magnetic-piece will back to original or horizon position (FIG. 2) (2). This movable function caused by the inner magnetic-piece has longer or heavier section always inside the sealed-unit. The opening-area of seal-unit only has shorter or lighter section so it will move basing on the (a) gravities theory or (b) balance theory. From FIG. 2 also show the 2 circle to show the movement path of the inner magnetic-piece (2) while from horizon or original position (2) to the pop-out or tilt position (2′). The Movement of the magnetic-piece (2) top will hit the sealed-unit (1) inner top wall or-and the shorter-section will hit the opening (3) edge wall so stop or-and hold the magnetic-piece to continue move and fall out from opening. This is one of preferred construction. It is appreciated for any alternative, or equivalent, or replaceable arrangement to arrange the said magnetic-piece (2) to move to had pop-out and horizon position changes and can be back-and-forth from one position to other position perfectly.

From FIG. 3) and FIG. 3A) disclosure the example to apply on other products which has housing (31) (31′) and have outside or inside installation for universal magnetic sealed-unit (32) (32′) those has a bracket or housing or base or accessories of the said sealed-unit to allow to use traditional installation or fix or assembly skill to assembly the said add-one sealed-unit (32) (32′) on the product inner or outside space. The current embodiment is one of assembly on outside housing of products.

From FIG. 3 and FIG. 3A disclosure the sealed-unit (32) (32′) have two ears has opening to allow use screw or pole or solvent or chemical compound or press-tight or fit-tight or ultrasonic sealing to add the said sealed-unit on the product. FIG. 3 show is the magnetic-piece (32) is under recess level. The FIG. 3A show the magnetic-piece (32′) is at pop-out position.

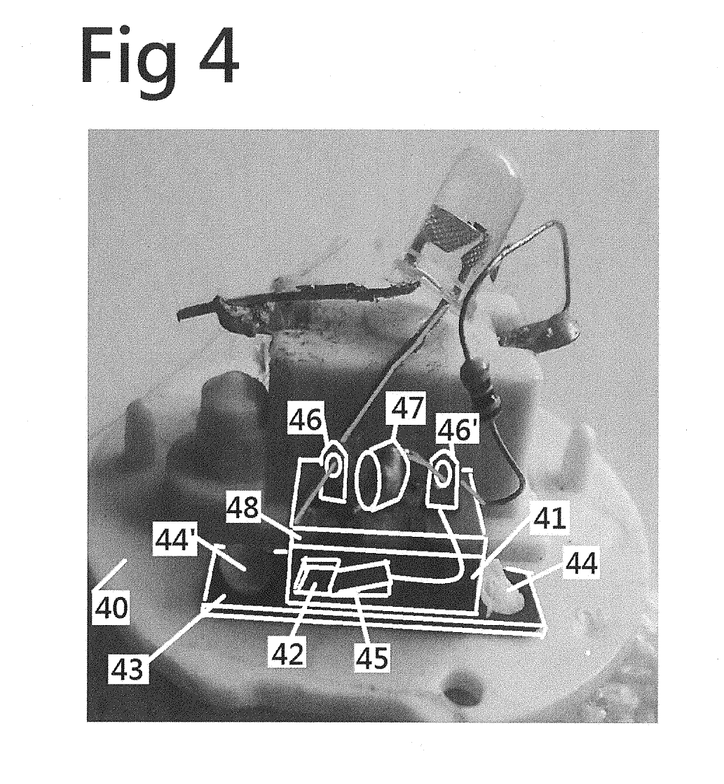

From FIG. 4 disclosure the universal magnetic sealed-unit (43) has opening (42) and inner conductive-parts or-and other electric parts & accessories or-and IC or-and sensor, switch, remote receiving circuit, other functional circuitry to make electric current or-and signal delivery to make the said Universal magnetic sealed-unit has not only (1) magnetic force to attach or detach or fix or install on metal-piece but also has (2) 2^{nd} function to delivery electric current or signals so can delivery power and make pre-determined functions including lighting or sound or wireless remote controller or wireless delivery signals or electric functions for eyes to see, ear to hear, nose to smell, mouth can eat, skin can feel functions.

From FIG. 4 disclosure the inner sealed-unit (41) has opening (42) to allow the magnetic-piece (not shown) to move and has conductive-piece (45) to build the electric connection with top of magnetic-piece. The conductive-piece (45) also may incorporated other conductive-wire to connect with the outside conductive-terminals (46′) which has connection with other electric-parts (47) which can have selected for capacitor, resistor, or other circuits or circuitry or IC to make the simple magnetic-piece (not shown) only had attachment to metal-piece function. This FIG. 4 disclosure all kind of electric parts & accessories incorporate with simple magnetic-force function to become has electric functions for any kind.

From FIG. 4 disclosure the Circuit or circuitry can also install outside the sealed unit which is other alternative construction. It is appreciated that all the electric parts & accessories or PCB or IC or circuit or circuitry can install within the sealed unit or outside sealed unit. The final goal is make sealed-unit has electric function all should be fall within the current invention scope as FIG. 4 details for all possibility.

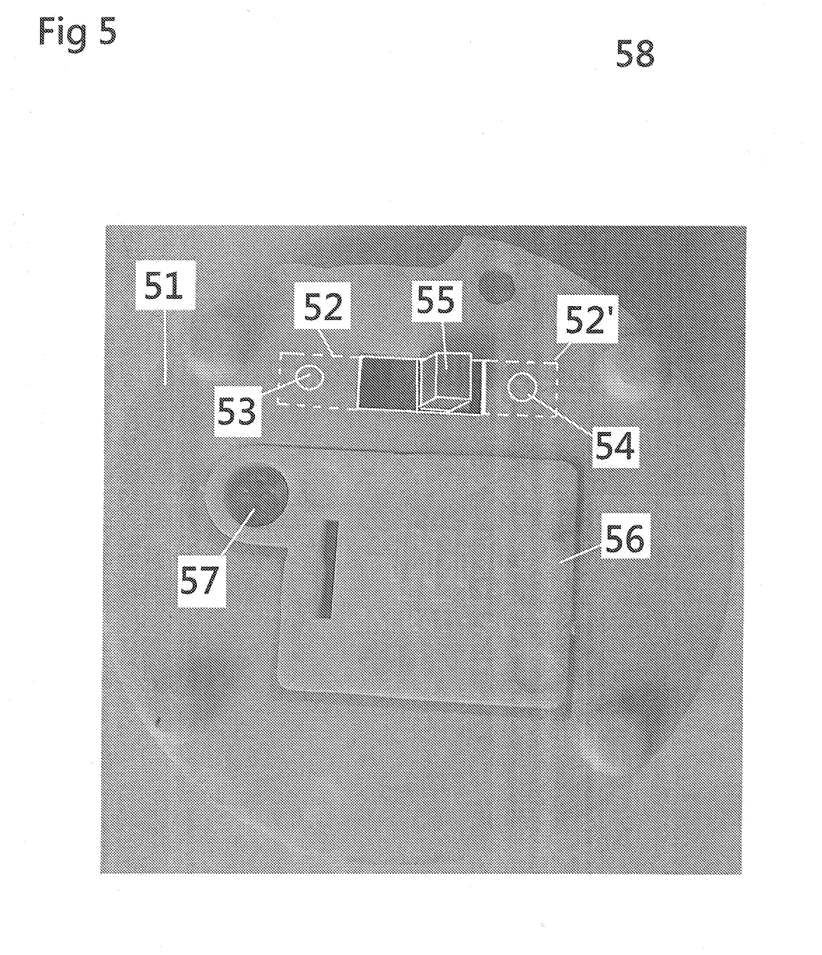

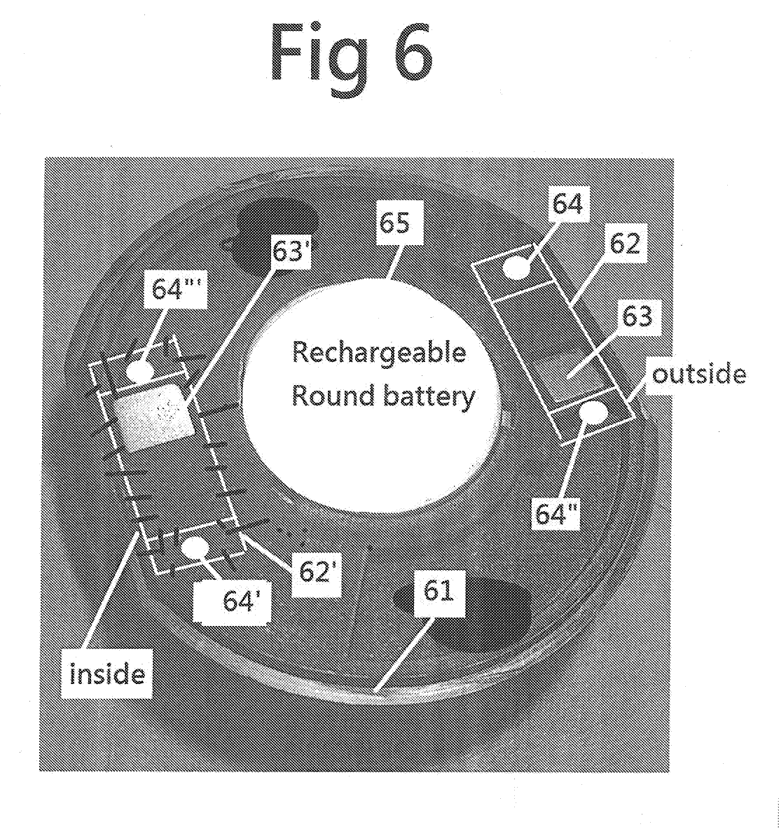

From FIG. 5 and FIG. 6 both is other products has add-on separated (a) Simple magnetic functions sealed unit or (b) multiple functions sealed-unit which has electric related functions. From FIG. 6 can see the solid-wire sealed-unit (62) is install on outside of products and dot-line sealed-unit (62′) is install inside of the products.

Both has housing, or base, or bracket, or frame to has holes (64) 964′) (64″) (64′″) or other arrangement such as pole, bar, pin or extended plastic board to assembly with products by screws, pole, bar, or use chemical combined, or use solvent to melt and combine with products plastic, or use ultra-sonic sealing to combine plastic material solid and tight, or staple together, or rivet together which can select from market available skill.

From FIG. 5 show another preferred product (51) which has battery door (56) to allow people to replace battery. The add-on Universal magnetic sealed-unit which is install from inside of the product which has two ears has opening to allow use melt-plastic-pole or use screw to fasten tight on products. The two ears can make many different ways such as made of from (a) plastic frame with two holes which can injection with housing of sealed-unit so can use melt plastic or use solvent to join plastic material, or use ultra-sonic sealing process, or (b) separated metal frame with two ears and hold the sealed-unit which can use melt plastic pole, bar, or use screws, or rivet, or stamping with product unit.

From FIG. 6 disclosure the products has rechargeable battery and as above discussed on FIG. 4 , the said rechargeable battery can be charged from two magnetic sealed-unit(s) so it is very good not only to has simple magnetic attachment function plus has the electric related all kind of functions.

So combined all above details description for current invention. Hereafter,

The current invention has all brief features as below listed 1 to 9.
1. A universal magnetic sealed unit consist of:
   At least one of magnetic-piece fit into a sealed-unit which has bracket or/and housing to allow install on product by (1) screw(s), or-and (2) poles, or-and (3) bar, or-and (4) push-tight, or-and (5) solvent to glue, or-and (6) chemical compound to fix, or-and (7) ultrasonic-seal together, or-and (8) other install skills.
   The said sealed-unit has at least one opening to allow the inner magnetic-piece can (a) tilt or (b) pop-out or (c) move and stopped by block-wall or block-designs to prevent from inner magnetic-piece fall-apart or separated from sealed unit, while the metal-surface or metal-piece within the magnetic-piece magnetic-force range.
   The said magnetic-piece has longer or-and heavier weight-section always inside the sealed than the shorter or-and lighter weight-section on opening-area.
   The said magnetic-piece longer or-and heavier weight-section always inside the sealed unit, so while no any metal-piece within the magnetic force range will cause the pop-out or tiled shorter or light weight-section back to horizon or shrink-back, or original positon from pop-out or tilt position.
   The said universal magnetic sealed-unit which is separated unit or parts that need to add-on to main products by attachment, or installation, or arrangement for all kind of products to make product can attach or fix or join with metal-piece.
2. The Universal magnetic sealed-unit, the said sealed unit has incorporate with conductive parts, or-and circuitry, or-and IC, or-and PCB to delivery current or-and electric signal to make the pre-determined electric functions.
3. The Universal magnetic sealed-unit, the said block-designs is one of wall or surface or bar or stopper or piece which will stop the inner magnetic-piece to fall out from the said opening of the said sealed-unit.
4. The Universal magnetic sealed-unit, the said products including all kind of electric or no-electric products which need to attach or detachable or install or fix on any metal-piece or metal-surface.
5. The Universal magnetic sealed-unit, the said magnetic-piece inside the sealed unit can be any shape or length with desired magnetic field strange to hold different weight of the said products.
6. The universal magnetic sealed-unit, the said sealed unit has built-in or add-on bracket or substrate or base which has installation or fix or attachment design so can make a perfect sealed-unit by one piece or multiple pieces parts or-and accessories.
7. The Universal magnetic sealed-unit, the said sealed unit has different size for different inner magnetic-piece for desired magnetic-field force to allow to hold different weight of product or-and products.
8. The Universal magnetic sealed-unit consist of;
   A sealed unit has inner magnetic-piece which can pop-out or tilt from opening without fall apart from the said sealed unit while the metal-piece within the said magnetic-force range of the said inner magnetic-piece.
   The magnetic-piece has longer or heavier section always inside the sealed-unit than the magnetic-piece shorter or lighter section which on opening-area, so basing on balance or gravity theory the said magnetic-piece will back from pop-out or tilt positon back to original or horizon or recess positon while the metal-piece is away from the magnetic-force range of inner magnetic-piece.
   The sealed-unit has bracket or base or housing has holes or opening(s) or housing to other design to allow install on the product housing by screw, solvent, chemical compound, ultrasonic sealing, fit tight or other skill for installation.
   The said product is an electric or non-electric product.
9. A universal magnetic sealed unit, consist of;
   A sealed unit which has movable inner magnetic-piece can pop-out or tilt from the opening to contact with metal piece which is within the magnetic-force of inner magnetic piece.
   The magnetic-piece has longer or heavier section always inside the sealed unit and has shorter or lighter section on opening areas, and basing on balanced or gravity theory the magnetic-piece will back from pop-out or tilt position back to original or horizon or recess position while the metal-piece is away from the magnetic force range of the said magnetic-piece.
   The sealed unit has parts or housing or bracket has holes or openings or housing to allow people to add the sealed-unit on the products to make products had magnetic attach or detachable functions.
   The said sealed unit incorporated with conductive-piece or-and circuitry or-and IC or controller to make the said sealed unit not only offer magnetic attachment function but also can delivery electric current or signal to make desired electric functions.

1. A universal magnetic sealed unit consist of:
At least one of magnetic-piece fit into a sealed-unit which has bracket or/and housing to allow install on product by (1) screw(s), or-and (2) poles, or-and (3) bar, or-and (4) push-tight, or-and (5) solvent to glue, or-and (6) chemical compound to fix, or-and (7) ultrasonic-seal together, or-and (8) other install skills.
The said sealed-unit has at least one opening to allow the inner magnetic-piece can (a) tilt or (b) pop-out or (c) move and stopped by block-wall or block-designs to prevent from inner magnetic-piece fall-apart or separated from sealed unit, while the metal-surface or metal-piece within the magnetic-piece magnetic-force range.
The said magnetic-piece has longer or-and heavier weight-section always inside the sealed than the shorter or-and lighter weight-section on opening-area.
The said magnetic-piece longer or-and heavier weight-section always inside the sealed unit, so while no any metal-piece within the magnetic force range will cause the pop-out or tiled shorter or light weight-section back to horizon or shrink-back, or original positon from pop-out or tilt position.
The said universal magnetic sealed-unit which is separated unit or parts that need to add-on to main products by attachment, or installation, or arrangement for all kind of products to make product can attach or fix or join with metal-piece.

2. The Universal magnetic sealed-unit as claim 1, the said sealed unit has incorporate with conductive parts, or-and circuitry, or-and IC, or-and PCB to delivery current or-and electric signal to make the pre-determined electric functions.

3. The Universal magnetic sealed-unit as claim 1, the said block-designs is one of wall or surface or bar or stopper or piece which will stop the inner magnetic-piece to fall out from the said opening of the said sealed-unit.

4. The Universal magnetic sealed-unit as claim 1, the said products including all kind of electric or no-electric products which need to attach or detachable or install or fix on any metal-piece or metal-surface.

5. The Universal magnetic sealed-unit as claim 1, the said magnetic-piece inside the sealed unit can be any shape or length with desired magnetic field strange to hold different weight of the said products.

6. The universal magnetic sealed-unit as claim 1, the said sealed unit has built-in or add-on bracket or substrate or base which has installation or fix or attachment design so can make a perfect sealed-unit by one piece or multiple pieces parts or- and accessories.

7. The Universal magnetic sealed-unit as claim 1, the said sealed unit has different size for different inner magnetic-piece for desired magnetic-field force to allow to hold different weight of product or-and products.

8. The Universal magnetic sealed-unit consist of;
A sealed unit has inner magnetic-piece which can pop-out or tilt from opening without fall apart from the said sealed unit while the metal-piece within the magnetic-force range of the said inner magnetic-piece.
The magnetic-piece has longer or heavier section always inside the sealed-unit than the magnetic-piece shorter or lighter section which on opening-area, so basing on balance or gravity theory the said magnetic-piece will back from pop-out or tilt positon back to original or horizon or recess positon while the metal-piece is away from the magnetic-force range of inner magnetic-piece.
The sealed-unit has bracket or base or housing has holes or opening(s) or housing to other design to allow install on the product housing by screw, solvent, chemical compound, ultrasonic sealing, fit tight or other skill for installation.
The said products are an electric or non-electric product.

9. A universal magnetic sealed unit, consist of;
A sealed unit which has movable inner magnetic-piece can pop-out or tilt from the opening to contact with metal piece which is within the magnetic-force of inner magnetic piece.
The magnetic-piece has longer or heavier section always inside the sealed unit and has shorter or lighter section on opening areas, and basing on balanced or gravity theory the magnetic-piece will back from pop-out or tilt position back to original or horizon or recess position while the metal-piece is away from the magnetic force range of the said magnetic-piece.
The sealed unit has parts or housing or bracket has holes or openings or housing to allow people to add the sealed-unit on the products to make products had magnetic attach or detachable functions.
The said sealed unit incorporated with conductive-piece or-and circuitry or-and IC or controller to make the said sealed unit not only offer magnetic attachment function but also can delivery electric current or signal to make desired electric functions.
